(19) United States
(12) Patent Application Publication
(10) Pub. No.: US 2003/0015397 A1
(43) Pub. Date: Jan. 23, 2003

(54) Portable adjustable attachable slot machine chute extension

(76) Inventor: Robert W. Coulter, Opelika, AL (US)

Correspondence Address: Robert W. Coulter, 1404 Sandray Drive, Opelika, AL, 36801, US

(21) Appl. No.: 09/838,734

(22) Filed: Apr. 19, 2001

(51) Int. Cl. G07F 1/04

(52) U.S. Cl. 194/353

(57) ABSTRACT

A telescopic slot chute for retrieval of payouts from slot machine or video type machine which has protrusions (26) (28) that act together as a clip for a hands free operation. The chute provides a passageway for coins discharged by a slot machine. The passageway extends from a coin discharge opening of the slot machine, attaching to the lip of the coin holding tray of the slot machine outer edge to the mouth of a cup or container or any other desired coin collecting unit.

### CROSS-REFERENCE TO RELATED APPLICATIONS

Not applicable.

### BACKGROUND

1. Field of Invention

This invention relates generally to gaming accessories and methods and, more specifically, to an improved device and method for providing a controlled payout to a person who plays a slot type machine.

2. Description of Prior Art

Slot machine play is an important source of revenue for a casino or other type of establishment having slot type machines for gaming purposes. Because of the importance of the slot machine revenue, the casino or establishment containing the slot machines usually tries to eliminate negative aspects of slot type machine play. The term slot machine or slot type machine as used in this application is intended to encompass all forms of gaming machines that utilize coins and/or payout in coins such as the famous “one armed bandits”, video machines such as video poker machines, keno machines, etc., etc.

When a gaming player makes or scores a win while playing a slot machine and/or desires to activate the machine's cash button to retrieve winnings stored in the machine, a lot of coins are usually disgorged by the machine into a coin holding tray. The player manually collects the coins from the tray and deposits them into, for example, the player's pocket, purse or pocketbook, fanny pack or plastic cup furnished by the casino.

Usually, the coins in the tray have been previously handled by a lot of people and often a player's hand or hands will become dirty due to handling the coins. Also people will often drop debris into the tray or even flick ashes into the tray. Although some manual contact with the inside of the tray and/or the coins in the tray may appear to be unavoidable, the player usually desires to limit this manual contact as much as possible.

Accordingly, there is a need for a device and method that limits the player's manual contact with the inside of the tray and/or with the coins that are disgorged by the machine. There is a slot chute that has been developed that a person has to hold under the machine's coin chute while at the same time hold the bucket with the other hand at the other end of the slot chute. This can prove to be very tricky and if the person moves the movable slot chute in just the wrong way, the coins will go all over the place. There is a need then for a device that will not only limit the player's manual contact with the coins but will also attach to most slot machine coin trays so that the person has two hands to hold the waiting bucket and then there is much less chance of the run away coins. Also there is a need for a slot chute device which will adapt to any machine coin tray size and yet be small enough to fit in ones purse or pocket. Casinos frown upon people sticking their hands under the slot machines' housing because there have been so many trying to actually put something up the coin slot and make the machine payout more than it is suppose to.

### SUMMARY

In accordance with the present invention a slot chute comprises two separate flat bodies with two raised sides that are placed one inside the other in a telescoping fashion with clips on the underside of the outer piece.

### OBJECTS AND ADVANTAGES

Accordingly, besides the objects and advantages of the slot chute described in my above patent, several objects and advantages of the present invention are:

(a) to provide an improved device and method for handling coins that are disgorged by a slot machine;

(b) to provide an improved device and method for significantly limiting or substantially eliminating manual contact with both the coins that are disgorged by a slot machine and the inside portion of the coin holding tray;

(c) to provide an improved device that will be easily used by most slot machine players because it allows two free hands to hold the bucket at the end of the chute due to the attachable clip feature;

(d) to provide an improved device that will adapt to most any slot machine tray size due to the telescopic feature.

Further objects and advantages are to provide a device that can be easily and conveniently used to collect coins, without damage to the machine, which is simple to use and inexpensive to manufacture, which can be used with most slot machines; which can be used repeatedly and which obviates the need of providing disposable towels to clean dirty hands. Still further objects and advantages will become apparent from a consideration of the ensuing description and drawings.

### DRAWING FIGURES

In the drawings, closely related figures have the same number but different alphabetic suffixes.

FIG. 1 is an imploded view of my invention.

FIG. 2 is a perspective view of my invention.

FIG. 3 is a side view of the inner tray of the slot chute.

FIG. 4 is a side view of the outer tray of the slot chute.

FIG. 5 is a view of the underside of the outer tray of the slot chute.

FIG. 6 is a frontal view of the outer tray of the slot chute.

FIG. 7 is a frontal view of the inner tray of the slot chute.

FIGS. 8A to 8B are views that show how the attachable slot chute will be positioned accordingly with a slot machine tray and how the clips, protrusions hold on to the machine coin tray.

### REFERENCE NUMERALS IN DRAWINGS

| | |
|---|---|
| 10 | side of outer tray |
| 12 | top edge of inner tray |
| 14 | top of tray of outer tray |
| 16 | top of tray of inner tray |
| 18 | side of inner tray |
| 20 | bottom of inner tray |
| 22 | slot cut out of outer tray |
| 24 | stop notches on inner tray |
| 26 | outer protrusions, clips |
| 28 | inner protrusion, clip |
| 30 | bottom of outer tray |

### DESCRIPTION

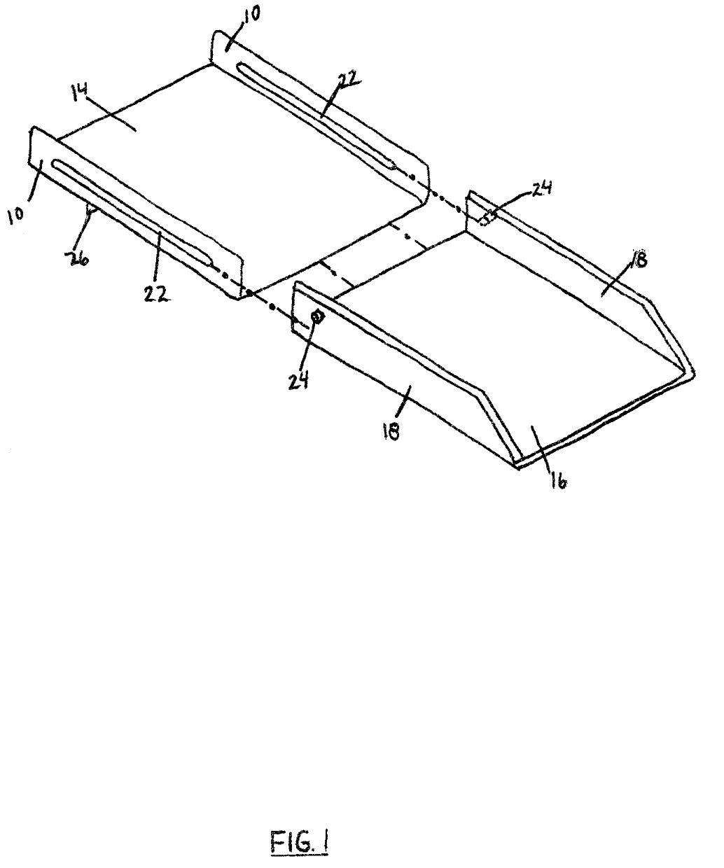

FIG. 1—Preferred Embodiment

A preferred embodiment of the chute of the present invention is illustrated in FIG. 1. The implosion of the chute is shown with the outer tray being 8.8 cm. in length by 7.4 cm. in width and the inner tray being 9.5 cm. by 7 cm. so that the inner tray can slide neatly inside the outer tray in a telescoping fashion. The sides of both trays 10, 18 are 1.8 cm high and at right angles to the base of the trays.

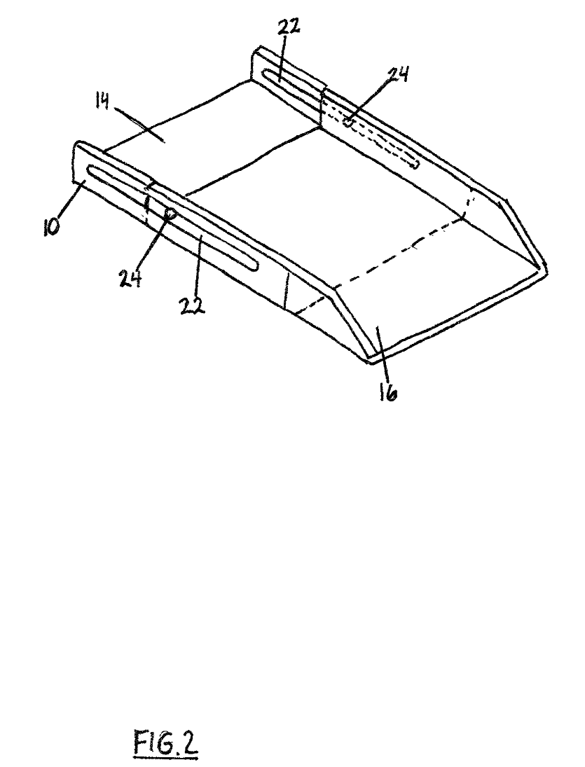

FIG. 2—Additional Embodiments

Additional embodiments are shown in FIG. 2. The perspective view of the chute of the present invention is illustrated. The chute is made of two trays one inside the other in a telescopic fashion. They both have flat bottoms 20 30 with raised sides 10 18. The trays can be made of plastic or any other material so as to allow the trays to remain stiff together and in shape but pliable enough to allow protrusions, clips, 26 28 to move enough to attach to the slot machine coin tray.

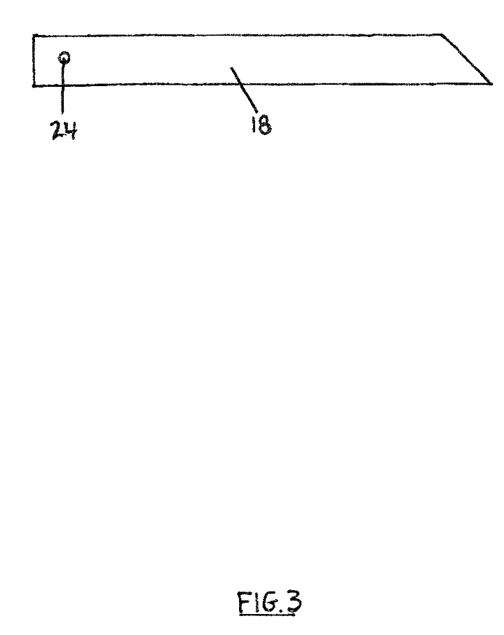

FIG. 3—Additional Embodiments

The inner tray has circular notches 24 on the outer part of each of its sides 18 which line up with elongated slot 22 of the outer tray. These notches 24 are located 1.2 cm from the straight side of the inner tray. The other end of inner tray side 18 is angled at 45 degrees as shown in FIG. 3.

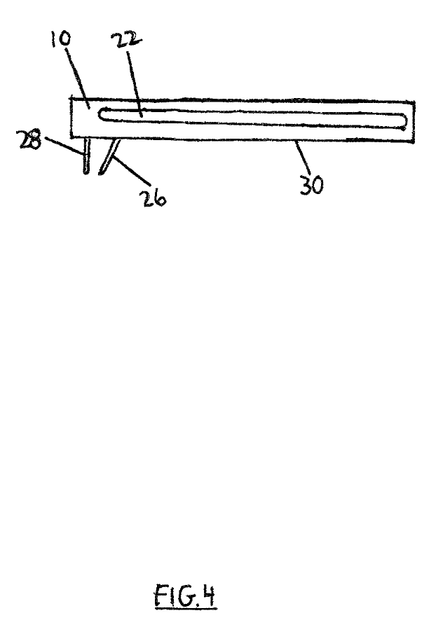

FIG. 4—Additional Embodiments

The outer tray has an elongated slot 22 cut out on each side 10 which is 6.6 cm by 35 0.cm.

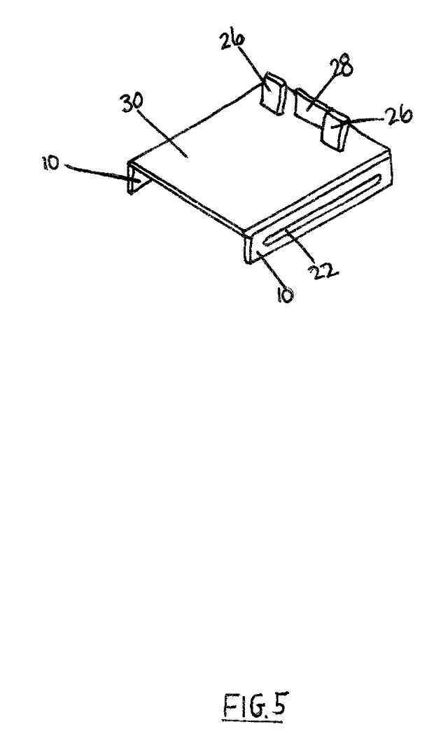

FIG. 5—Additional Embodiments

Additional embodiments are shown in FIG. 5. Attached to one end of the bottom of outer tray 30 are three protrusions 26 28 spaced and placed so that they act as a clip for the chute mechanism. The two outer protrusions 26 are 1.5 cm by 1.2 cm rectangular in shape placed at the bottom of tray 30 making a 10 degree angle towards inner protrusion 28. The inner protrusion 28 is 1.2 cm by 1.8 cm and rectangular in shape and placed at a 90 degree angle to bottom of outer tray 30. The distance between two outer protrusions 26 is 1.7 cm. The distance between the base of outer protrusion 26 and base of the inner protrusion 28 is 0.4 cm.

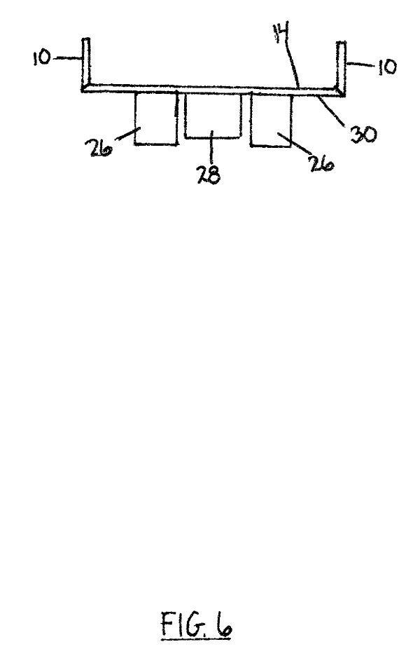

FIG. 6—Additional Embodiments

Additional embodiments are shown in FIG. 6. This frontal view shows the placement of plastic protrusions 26 and 28 underneath the outer tray.

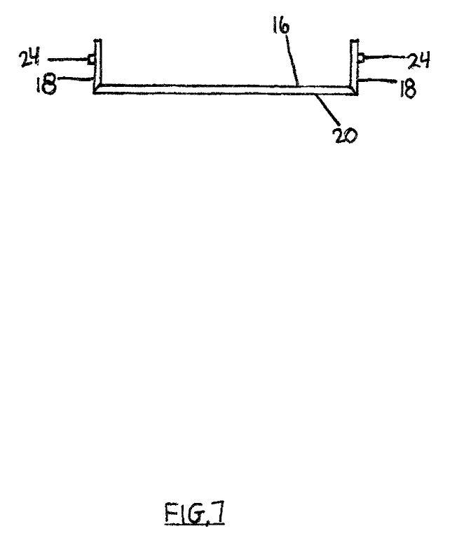

FIG. 7—Additional Embodiments

Additional embodiments are shown in FIG. 7. This frontal view of the inner tray shows the placement of stop notches 24.

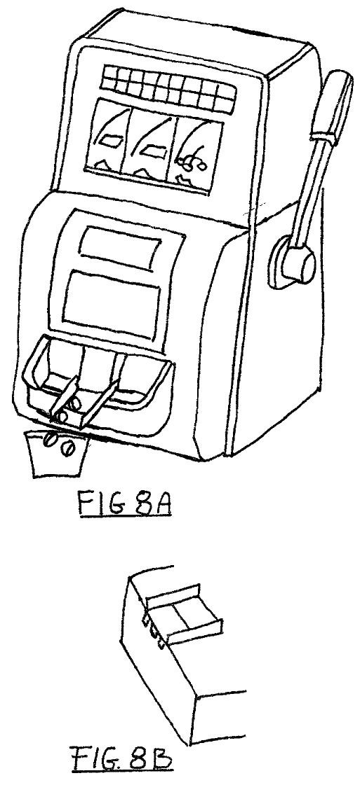

FIG. 8A & 8B—Additional Embodiments

Additional embodiments are shown in FIGS. 8A & 8B. This view shows the placement of the portable slot chute in relation to the slot machine coin chute and coin tray. FIG. 8B shows that inner protrusion 28 will be on the outside of the coin tray and two outer protrusions 26 will be on the inside of the coin tray thus forming a clip to hold the portable chute in place hands free.

Advantages

From the description above, a number of advantages of my portable attachable adjustable coin slot chute extension become evident:

(a) The slot chute will obviate a need for slot machine owners to provide disposable towels to clean players hands.

(b) The slot chute will obviate a need for slot machine owners to have as many clean up crews to clean the coin trays of the disposed towel wrappers.

(c) The slot chute will allow players to collect payouts quicker thus they will have more time to play.

(d) The slot chute will more efficiently transfer coins from the slot machine to a container preventing runaway coins on the floors of the casinos.

(e) The telescoping slot chute will encourage more people to carry and use it when gambling and retrieving payouts since it fits conveniently in so many handy carrying places.

(f) The adjustable feature of the chute is an encouragement for people to use this slot chute extension because they will know that it will help them to retrieve payouts on most normally sized coin payout slot or video machines.

(g) The clip feature of the coin slot extension is helpful to the people who are “all fingers” and can't seem to get the coins in the waiting vessel. The clip on feature is easily used by anyone allowing hands free for keeping the bucket in place to receive the coins coming down the extension chute.

Operation

The manner of using the portable adjustable attachable slot machine chute extension is similar to other chute extensions however the adjustable feature is unique. Namely, one takes the end of the chute without the protrusions and slides it under the machines own coin chute. Holding this end in place with the other hand one extends the portable chute by grasping the outer tray and pulling it so that protrusions 26 28 underneath line up with the lip of the machine's coin tray edge. Once the length is correct one simply pushes down on the outer tray so protrusions 26 28 catch onto the machine's coin tray. The chute will then stay in place and be ready to receive the payout coins. When the payout is finished simply lift the chute up off the coin tray and out from under the machines own coin chute, collapse and place in a convenient holding area, either a pocket or pocketbook for example.

Conclusion, Ramifications, and Scope

Accordingly, the reader will see that the portable, adjustable and attachable feature of this invention can make using this slot chute easy and convenient, coin payout can be made easily, quickly, efficiently and cleanly. In addition, the casinos will be happier to not have a persons hands under the machine coin chute housing for so long as to arouse suspicion of foul play. Furthermore the slot chute has additional advantages in that

it provides for the machines turnover to be greater and more money to be able to be played through because the time taking to collect the payout is decreased;

it permits the slot machine players to have a cleaner playing time when using the machines because the payout retrieval eliminates hands from having to touch the dirty coins and anything else dirty in the machine coin tray such as ashes;

it obviates the need for so many of the disposable towels that the casinos provide to clean the hands of the player;

it makes the task of cleaning the machines buttons easier for the casinos because the players won't be operating their machines with the dirty hands from collecting the payout with their hands;

it offers a smooth place on the slot machine portable chute extension to print the logo of the casino or slot machine house which will further remind the player of the plentiful payouts made at that particular casino from where he received the chute.

Thus the scope of the invention should be determined by the appended claims and their legal equivalents, rather than by the examples given.

I claim:

1. In the method of handling coins that are discharged by a slot machine, the steps of:
Providing a chute with two separate trays one inside the other, connected by the inner tray notches sliding inside cutout sections of the outer tray:
Inserting said chute into a slot machine below a coin discharge opening therein to capture and redirect all coins discharged by the slot machine; said step of providing includes a chute that forms a “hands free” passageway that extends over and away from a coin holding tray of the slot machine; said step of providing includes a chute with protrusions on the underside of the outer tray which will act as a clip to attach said chute to the machine coin holding tray.

2. The method of claim 1 includes the additional step of deflecting all the coins out of the bottom portion of said chute with attachable chute.

3. A chute of claim 1 for handling coins discharged by a slot machine, comprising in combination

4. A slot machine; a telescopic coin chute for handling coins discharged by said slot machine, said coin chute comprising: two flat bottom trays, one inside the other each with a pair of sides at right angle to the bottom.

5. The chute of claim 1 has an inner tray with sides having two notches, one on outside of each side and the ends of one end of the sides being tapered.

6. The chute of claim 1 has an outer tray with sides having cut out slots to accommodate the notches of the inner tray.

7. The outer tray of claim 6 has a bottom with three protrusions placed so that a clip is formed to hold the chute in place during use.

8. The chute of claim 3 wherein an upper surface of said bottom is made from plastic having a low coefficient of friction, stiff enough to hold shape yet pliable enough so the protrusions have some flexibility to be able to perform as a clip.

9. The chute of claim 3 wherein said bottoms, said sides are made from one material additionally comprising a layer carried on interior surfaces of said chute having low coefficient of friction, with some small degree of flexibility for protrusions to act together as a clip.
